(19) United States
(12) Patent Application Publication
(10) Pub. No.: US 2022/0360781 A1
(43) Pub. Date: Nov. 10, 2022

(54) VIDEO ENCODING AND DECODING USING BLOCK AREA BASED QUANTIZATION MATRICES

(71) Applicant: InterDigital VC Holdings France, SAS, Cesson-Sevigne (FR)

(72) Inventors: Philippe De Lagrange, Betton (FR); Philippe Bordes, LAILLE (FR); Karam Naser, Mouazé (FR); Edouard Francois, Bourg des Comptes (FR)

(21) Appl. No.: 17/762,526

(22) PCT Filed: Sep. 8, 2020
(86) PCT No.: PCT/EP2020/075092

§ 371 Date: Mar. 22, 2022

(30) Foreign Application Priority Data
Sep. 23, 2019 (EP) 19306165.2

(51) Int. Cl. H04N 19/126; H04N 19/176; H04N 19/196

(52) U.S. Cl. CPC H04N 19/126; H04N 19/176; H04N 19/196

(57) ABSTRACT

In a video coding system, it is proposed to determine the quantization matrix based on the block area instead of the maximal value of the block size dimension (width or height). Having specific quantization matrix for each block size actually allows adaptation to image content, and thus results in better visual quality. Indeed, choosing a quantization matrix of equal-area better match the idea of “size” than choosing a quantization matrix of the maximal dimension of the rectangular block. In at least one embodiment, the quantization matrix used for video coding or decoding is selected based on a block area identifier whose value is determined as the integer value of an average of the log 2 of block width and height. Encoding and decoding methods, encoding and decoding apparatuses, non-transitory computer readable medium and computer program are described.

### TECHNICAL FIELD

The disclosure is in the field of video compression, and at least one embodiment relates more specifically to video encoding and decoding using quantization matrices that are based on block area.

### BACKGROUND ART

To achieve high compression efficiency, image and video coding schemes usually employ prediction and transform to leverage spatial and temporal redundancy in the video content. Generally, intra or inter prediction is used to exploit the intra or inter frame correlation, then the differences between the original image block and the predicted image block, often denoted as prediction errors or prediction residuals, are transformed, quantized and entropy coded. During encoding, the original image block is usually partitioned/split into sub-blocks using various partitioning such as quad-tree for example. To reconstruct the video, the compressed data is decoded by inverse processes corresponding to the prediction, transform, quantization and entropy coding.

### SUMMARY

In at least one embodiment, a video coding system comprises determining a quantization matrix for a block of samples based on the block area instead of the maximal value of the block size dimension (width or height). In at least one embodiment, the quantization matrix used for video coding or decoding is selected based on a block area identifier whose value is determined as the integer value of an average of the log 2 of block width and height.

A first aspect is directed to a method for encoding picture data comprising a quantization of a block of a picture, wherein a quantization matrix used for the quantization of the block is selected based on a value representative of the area of the block. A variant of first aspect further comprises obtaining an information representative of a block of the picture, performing quantization of the block of picture using selected quantization matrix, and encoding the quantized block of picture.

A second aspect is directed to a method for decoding picture data comprising an inverse quantization of a block of a picture, wherein a quantization matrix used for the inverse quantization of the block is selected based on a value representative of the area of the block. A variant of second aspect further comprises obtaining an information representative of a quantized block of the picture, performing inverse quantization of the block of picture using selected quantization matrix, and decoding the dequantized block of picture.

A third aspect is directed to an apparatus for encoding for encoding picture data comprising an encoder configured to perform a quantization of a block of a picture, wherein a quantization matrix used for the quantization of the block is selected based on a value representative of the area of the block. In a variant of third aspect, the encoder is further configured to obtain an information representative of a block of the picture, perform quantization of the block of picture using selected quantization matrix, and encode the quantized block of picture.

A fourth aspect is directed to an apparatus for decoding picture data comprising a decoder configured to perform an inverse quantization of a block of a picture, wherein a quantization matrix used for the inverse quantization of the block is selected based on a value representative of the area of the block. In a variant of fourth aspect, the decoder is further configured to obtain an information representative of a quantized block of the picture, perform inverse quantization of the block of picture using selected quantization matrix, and decode the dequantized block of picture.

In further variants of first, second, third and fourth aspects, the value representative of the block area is determined based on an average of the log 2 of the block width and height.

One or more of the present embodiments are directed to a non-transitory computer readable storage medium having stored thereon instructions for encoding or decoding video data according to at least part of any of the methods of first or second aspect described above. One or more of the present embodiments are directed to a computer program product including instructions for performing at least part of any of the methods of first or second aspect described above.

### BRIEF SUMMARY OF THE DRAWINGS

FIG. 1 illustrates a block diagram of a video encoder according to an embodiment.

FIG. 2 illustrates a block diagram of a video decoder according to an embodiment.

FIG. 3 illustrates a block diagram of an example of a system in which various aspects and embodiments are implemented.

FIG. 4 illustrates an example of inferring transform coefficients to zero.

FIG. 5 describes an encoding method according to an embodiment.

FIG. 6 describes a decoding method according to an embodiment.

### DETAILED DESCRIPTION

Various embodiments relate to a post-processing method for a predicted value of a sample of a block of an image, the value being predicted according to an intra prediction angle, wherein the value of the sample is modified after the prediction so that it is determined based on a weighting of the difference between a value of a left reference sample and the obtained predicted value for the sample, wherein the left reference sample is determined based on the intra prediction angle. Encoding method, decoding method, encoding apparatus, decoding apparatus based on this post-processing method are proposed.

Moreover, the present aspects, although describing principles related to particular drafts of VVC (Versatile Video Coding) or to HEVC (High Efficiency Video Coding) specifications, are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

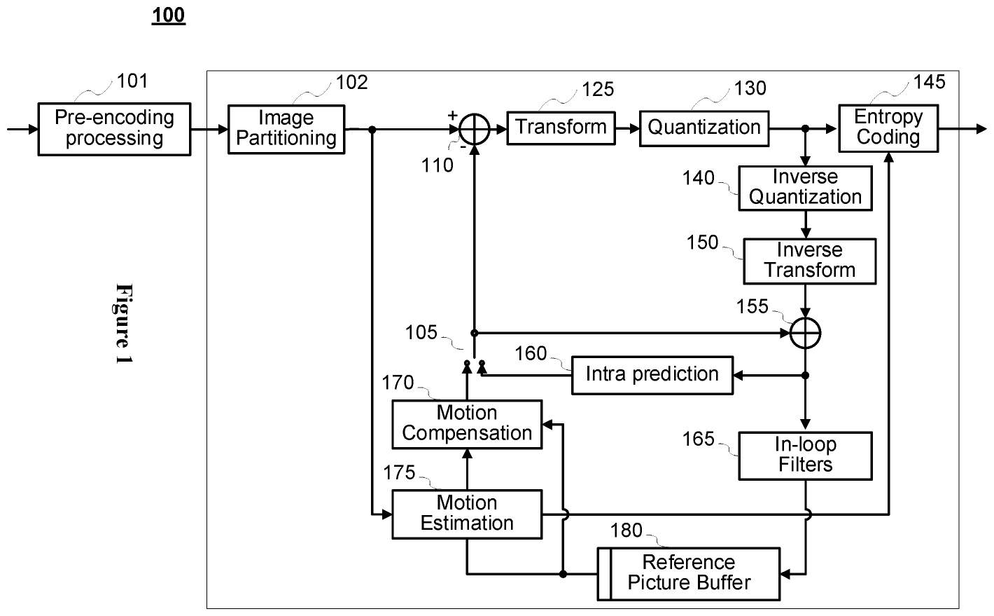

FIG. 1 illustrates a video encoder 100. Variations of this encoder 100 are contemplated, but the encoder 100 is described below for purposes of clarity without describing all expected variations. Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset), Adaptive Loop-Filter (ALF) filtering to reduce encoding artifacts. The filtered image is stored at a reference picture buffer (180).

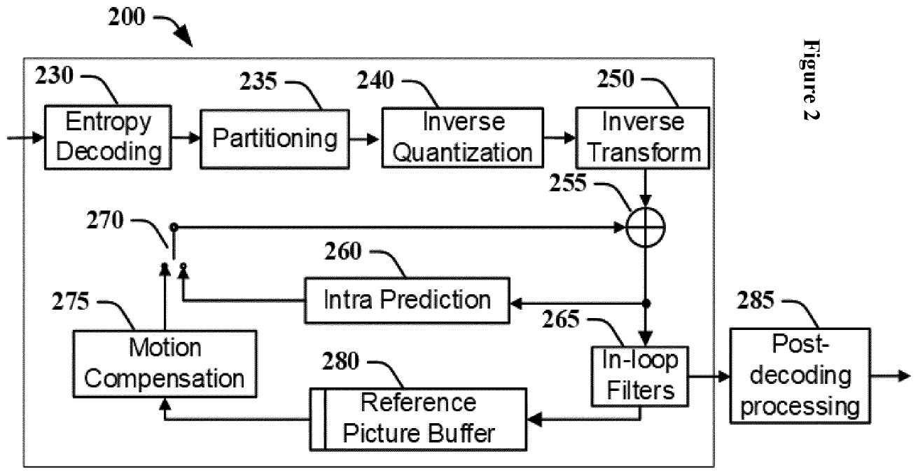

FIG. 2 illustrates a block diagram of a video decoder 200. In the decoder 200, a bitstream is decoded by the decoder elements as described below. Video decoder 200 generally performs a decoding pass reciprocal to the encoding pass. The encoder 100 also generally performs video decoding as part of encoding video data. In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280).

The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

FIG. 3 illustrates a block diagram of an example of a system in which various aspects and embodiments are implemented. System 1000 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1000, singly or in combination, can be embodied in a single integrated circuit (IC), multiple ICs, and/or discrete components. For example, in at least one embodiment, the processing and encoder/decoder elements of system 1000 are distributed across multiple ICs and/or discrete components. In various embodiments, the system 1000 is communicatively coupled to one or more other systems, or other electronic devices, via, for example, a communications bus or through dedicated input and/or output ports. In various embodiments, the system 1000 is configured to implement one or more of the aspects described in this document.

The system 1000 includes at least one processor 1010 configured to execute instructions loaded therein for implementing, for example, the various aspects described in this document. Processor 1010 can include embedded memory, input output interface, and various other circuitries as known in the art. The system 1000 includes at least one memory 1020 (e.g., a volatile memory device, and/or a non-volatile memory device). System 1000 includes a storage device 1040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1040 can include an internal storage device, an attached storage device (including detachable and non-detachable storage devices), and/or a network accessible storage device, as non-limiting examples.

System 1000 includes an encoder/decoder module 1030 configured, for example, to process data to provide an encoded video or decoded video, and the encoder/decoder module 1030 can include its own processor and memory. The encoder/decoder module 1030 represents module(s) that can be included in a device to perform the encoding and/or decoding functions. As is known, a device can include one or both of the encoding and decoding modules. Additionally, encoder/decoder module 1030 can be implemented as a separate element of system 1000 or can be incorporated within processor 1010 as a combination of hardware and software as known to those skilled in the art.

Program code to be loaded onto processor 1010 or encoder/decoder 1030 to perform the various aspects described in this document can be stored in storage device 1040 and subsequently loaded onto memory 1020 for execution by processor 1010. In accordance with various embodiments, one or more of processor 1010, memory 1020, storage device 1040, and encoder/decoder module 1030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 1010 and/or the encoder/decoder module 1030 is used to store instructions and to provide working memory for processing that is needed during encoding or decoding. In other embodiments, however, a memory external to the processing device (for example, the processing device can be either the processor 1010 or the encoder/decoder module 1030) is used for one or more of these functions. The external memory can be the memory 1020 and/or the storage device 1040, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 1000 can be provided through various input devices as indicated in block 1130. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 3, include composite video.

In various embodiments, the input devices of block 1130 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 1000 to other electronic devices across USB and/or HDMI connections. It is to be understood that various aspects of input processing, for example, Reed-Solomon error correction, can be implemented, for example, within a separate input processing IC or within processor 1010 as necessary. Similarly, aspects of USB or HDMI interface processing can be implemented within separate interface ICs or within processor 1010 as necessary. The demodulated, error corrected, and demultiplexed stream is provided to various processing elements, including, for example, processor 1010, and encoder/decoder 1030 operating in combination with the memory and storage elements to process the datastream as necessary for presentation on an output device.

Various elements of system 1000 can be provided within an integrated housing, Within the integrated housing, the various elements can be interconnected and transmit data therebetween using suitable connection arrangement 1140, for example, an internal bus as known in the art, including the Inter-IC (I2C) bus, wiring, and printed circuit boards.

The system 1000 includes communication interface 1050 that enables communication with other devices via communication channel 1060. The communication interface 1050 can include, but is not limited to, a transceiver configured to transmit and to receive data over communication channel 1060. The communication interface 1050 can include, but is not limited to, a modem or network card and the communication channel 1060 can be implemented, for example, within a wired and/or a wireless medium.

Data is streamed, or otherwise provided, to the system 1000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 1060 and the communications interface 1050 which are adapted for Wi-Fi communications. The communications channel 1060 of these embodiments is typically connected to an access point or router that provides access to external networks including the Internet for allowing streaming applications and other over-the-top communications. Other embodiments provide streamed data to the system 1000 using a set-top box that delivers the data over the HDMI connection of the input block 1130. Still other embodiments provide streamed data to the system 1000 using the RF connection of the input block 1130. As indicated above, various embodiments provide data in a non-streaming manner. Additionally, various embodiments use wireless networks other than Wi-Fi, for example a cellular network or a Bluetooth network.

The system 1000 can provide an output signal to various output devices, including a display 1100, speakers 1110, and other peripheral devices 1120. The display 1100 of various embodiments includes one or more of, for example, a touchscreen display, an organic light-emitting diode (OLED) display, a curved display, and/or a foldable display. The display 1100 can be for a television, a tablet, a laptop, a cell phone (mobile phone), or other device. The display 1100 can also be integrated with other components (for example, as in a smart phone), or separate (for example, an external monitor for a laptop). The other peripheral devices 1120 include, in various examples of embodiments, one or more of a stand-alone digital video disc (or digital versatile disc) (DVR, for both terms), a disk player, a stereo system, and/or a lighting system. Various embodiments use one or more peripheral devices 1120 that provide a function based on the output of the system 1000. For example, a disk player performs the function of playing the output of the system 1000.

In various embodiments, control signals are communicated between the system 1000 and the display 1100, speakers 1110, or other peripheral devices 1120 using signaling such as AV.Link, Consumer Electronics Control (CEC), or other communications protocols that enable device-to-device control with or without user intervention. The output devices can be communicatively coupled to system 1000 via dedicated connections through respective interfaces 1070, 1080, and 1090. Alternatively, the output devices can be connected to system 1000 using the communications channel 1060 via the communications interface 1050. The display 1100 and speakers 1110 can be integrated in a single unit with the other components of system 1000 in an electronic device such as, for example, a television. In various embodiments, the display interface 1070 includes a display driver, such as, for example, a timing controller (T Con) chip.

The display 1100 and speaker 1110 can alternatively be separate from one or more of the other components, for example, if the RF portion of input 1130 is part of a separate set-top box. In various embodiments in which the display 1100 and speakers 1110 are external components, the output signal can be provided via dedicated output connections, including, for example, HDMI ports, USB ports, or COMP outputs.

The embodiments can be carried out by computer software implemented by the processor 1010 or by hardware, or by a combination of hardware and software. As a non-limiting example, the embodiments can be implemented by one or more integrated circuits. The memory 1020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1010 can be of any type appropriate to the technical environment, and can encompass one or more of microprocessors, general purpose computers, special purpose computers, and processors based on a multi-core architecture, as non-limiting examples.

The technical field of the invention is related to the quantization step of a video compression scheme.

Conventional video coding systems use quantization matrices in the dequantization process where coded block frequency-transformed coefficients are scaled by the current quantization step and further scaled by a quantization matrix (QM), for example as follows:

d[x][y]=Clip3(coeffMin, coeffMax, ((TransCoeffLevel[xTbY][yTbY][cIdx][x][y]*m[x][y]*levelScale[qP % 6]<<(qP/6))+(1<<(bdShift−1)))>>bdShift)

Where:

TransCoeffLevel[ . . . ] are the transformed coefficients absolute values for the current block identified by its spatial coordinates xTbY, yTbY and its component index cIdx.

x and y are the horizontal/vertical frequency indices.

qP is the current quantization parameter.

the multiplication by levelScale[qP % 6] and left shift by (qP/6) is the equivalent of the multiplication by quantization step qStep=(levelScale[qP % 6]<<(qP/6))

m[ . . . ][ . . . ] is the two-dimensional quantization matrix

bdShift is an additional scaling factor to account for image sample bit depth. The term (1<<(bdShift−1)) serves the purpose of rounding to the nearest integer.

d[ . . . ] are the resulting dequantized transformed coefficients absolute values

In the example of HEVC video coding system, the syntax illustrated in Table 1 is used to transmit quantization matrices.

TABLE 1

| | Descriptor |
|---|---|
| scaling_list_data( ) { | |
| for( sizeId = 0; sizeId < 4; sizeId++ ) | |
| for( matrixId = 0; matrixId < 6; matrixId += ( sizeId = = 3 ) ? 3 : 1 ) { | |
| scaling_list_pred_mode_flag[ sizeId ][ matrixId ] | u(1) |
| if( ! scaling_list_pred_mode_flag[ sizeId ][ matrixId ] ) | |
| scaling_list_pred_matrix_id_delta[ sizeId ][ matrixId ] | ue(v) |
| else { | |
| nextCoef = 8 | |
| coefNum = Min( 64, ( 1 << ( 4 + ( sizeId << 1 ) ) ) ) | |
| if( sizeId > 1 ) { | |
| scaling_list_dc_coef_minus8[ sizeId − 2 ][ matrixId ] | se(v) |
| nextCoef = scaling_list_dc_coef_minus8[ sizeId − 2 ][ matrixId ] + | |
| 8 | |
| } | |
| for( i = 0; i < coefNum; i++) { | |
| scaling_list_delta_coef | se(v) |
| nextCoef = (nextCoef + scaling_list_delta_coef + 256 ) % 256 | |
| ScalingList[ sizeId ][ matrixid ][ i ] = nextCoef | |
| } | |
| } | |
| } | |
| } | |

In this context:

A different matrix is specified for each transform size (sizeId)

For a given transform size, 6 matrices are specified, for intra/inter coding and Y/Cb/Cr components

A matrix can be either
Copied from a previously transmitted matrix of the same size, if scaling_list_pred_mode_flag is zero (the reference matrixId is obtained as matrixId—scaling_list_pred_matrix_id_delta)
Copied from default values specified in the standard (if both scaling_list_pred_mode_flag and scaling_list_pred_matrix_id_delta are zero)
Fully specified in DPCM coding mode, using exp-Golomb entropy coding, in up-right diagonal scanning order.

For block sizes greater than 8×8, only 8×8 coefficients are transmitted for signaling the quantization matrix in order to save coded bits. Coefficients are then interpolated using zero-hold (=repetition), except for DC coefficient which is transmitted explicitly.

In the example of VVC video coding system, more quantization matrices are required due to a higher number of block sizes.

Conventionally, a QM is identified by two parameters, matrixId and sizeId. This is illustrated in the following two tables. Table 2 illustrates the block size identifier used in the example of VVC draft 6.

TABLE 2

| Luma | Chroma | sizeId |
|---|---|---|
| — | — | 0 |
| — | 2 × 2 | 1 |
| 4 × 4 | 4 × 4 | 2 |
| 8 × 8 | 8 × 8 | 3 |
| 16 × 16 | 16 × 16 | 4 |
| 32 × 32 | 32 × 32 | 5 |
| 64 × 64 | — | 6 |

It should be noted that in this example of VVC draft 6, MODE_INTER QMs are also used for MODE_IBC (Intra Block Copy).

Table 3 illustrates the quantization matrix identifier used in this example.

TABLE 3

| CuPredMode | cIdx (Colour component) | matrixId |
|---|---|---|
| MODE_INTRA | 0 (Y) | 0 |
| MODE_INTRA | 1 (Cb) | 1 |
| MODE_INTRA | 2 (Cr) | 2 |
| MODE_INTER | 0 (Y) | 3 |
| MODE_INTER | 1 (Cb) | 4 |
| MODE_INTER | 2 (Cr) | 5 |

The combination of both identifiers (matrixId, sizeId) is shown in the table 4.

TABLE 4

| | | | | | | | |
|---|---|---|---|---|---|---|---|
| INTRA | Y | | 0, 2 | 0, 3 | 0, 4 | 0, 5 | 0, 6 |
| | Cb | 1, 1 | 1, 2 | 1, 3 | 1, 4 | 1, 5 | |
| | Cr | 2, 1 | 2, 2 | 2, 3 | 2, 4 | 2, 5 | |
| INTER | Y | | 3, 2 | 3, 3 | 3, 4 | 3, 5 | 3, 6 |
| | Cb | 4, 1 | 4, 2 | 4, 3 | 4, 4 | 4, 5 | |
| | Cr | 5, 1 | 5, 2 | 5, 3 | 5, 4 | 5, 5 | |

| | | | | | | |
|---|---|---|---|---|---|---|
| Block size: max | 2 | 4 | 8 | 16 | 32 | 64 |
| (width, height) | | | | | | |

| | | | | |
|---|---|---|---|---|
| Signaled QM coefficients | 2 × 2 | 4 × 4 | 8 × 8 | 8 × 8 + DC |

For block sizes greater than 8×8, only 8×8 coefficients and the DC coefficients are transmitted. QM of the correct size is reconstructed using zero-hold interpolation. For example, for a 16×16 block, every coefficient is repeated twice in both directions, then the DC coefficient is replaced by the transmitted one.

For rectangular blocks, the size retained for QM selection (sizeId) is the larger dimension, i.e. maximum of width and height. For example, for a 4×16 block, a QM for 16×16 block size is selected. Then, the reconstructed 16×16 matrix is decimated vertically by a factor 4 to obtain the final 4×16 quantization matrix (i.e. 3 lines out of 4 are skipped).

Relevant text in the example of VVC draft 6 semantics section is shown below, with QM selection underlined:
For a quantization matrix with rectangular size, the five-dimensional array ScalingFactor[wId][hId][matrixId][x][y], with wId=0 . . . 6, hId=0 . . . 6, matrixId=0 . . . 5, x=0 . . . (1<<wId)−1, y=0 . . . (1<<hId)−1, and wId!=hId, specifies the array of scaling factors for size (1<<wId)×(1<<hId). The elements of ScalingFactor[wId][hId][matrixId][x][y] are generated by using ScalingList[maxSizeId][matrixId][i] with maxSizeId=max(wId, hId), as follows:

k=min(maxSizeId, 3),

x=DiagScanOrder[k][k][i][0]

y=DiagScanOrder[k][k][i][1]

ratioW=(1<<wId)/(1<<k)

ratioH=(1<<hId)/(1<<k)

diffWH=1<<abs(wId−hId) (7-86)

if(wId>hId)

ScalingFactor[wId][hId][matrixId][x][y]=ScalingList[maxSizeId][matrixId]

[Raster2DiagScanPos[k][k][(1<<k)*((y*diffWH)/ratioW)+x/ratioW]]

else(wId<hId)

ScalingFactor[wId][hId][matrixId][x][y]=ScalingList[maxSizeId][matrixId]

[Raster2DiagScanPos[k][k][(1<<k)*(y/ratioH)+(x*diffWH)/ratioH]]

For the following, we refer to QMs for a given family of block sizes (square or rectangular) as size-N, in relation to sizeId and the square block size it is used for: for example, for block sizes 16×16 or 16×4, the QMs are identified as size-16 (sizeId 4 in VVC draft 6). The size-N notation is used to differentiate from exact block shape, and from the number of signaled QM coefficients (limited to 8×8, as shown in table 4).

Furthermore, in the example of VVC draft 6, for size-64, QM coefficients for the bottom-right quadrant are not transmitted (they are inferred to 0, which is called “zero-out” in the following). This is implemented by the “x>=4 && y>=4” condition in the scaling list data syntax. This avoid transmitting QM coefficients that are never used by the transformation/quantization process: indeed, in VVC, for transform block sizes larger than 32 in any dimension (64×N, N×64, with N<=64), any transformed coefficient with x/y frequency coordinate larger or equal to 32 is not transmitted and inferred to zero, consequently, no quantization matrix coefficient is needed to quantize it.

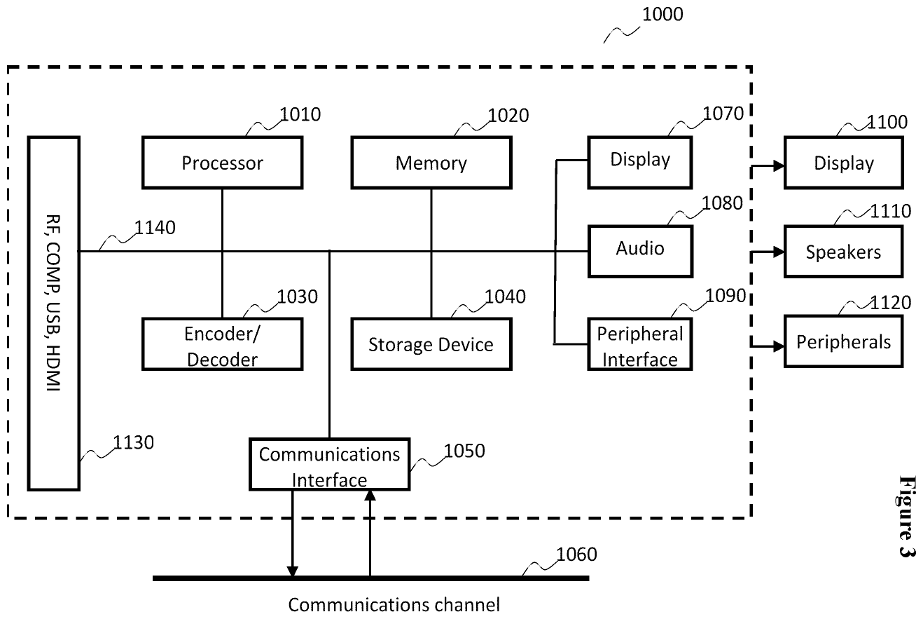

FIG. 4 illustrates an example of inferring transform coefficients to zero. In this figure, hatched area corresponds to transform coefficients inferred to zero in the horizontal (picture at the left) and vertical directions (picture at the right).

Modifications of QM syntax and prediction have been proposed in JVET-O0223 and EP application 19305802.1. This alternate technique is also considered in this disclosure.

In JVET-O0223, QMs are transmitted from larger to smaller order, and allow prediction from all previously transmitted QMs, including from QMs intended from larger block size. Prediction here means copy, or decimation if the reference is larger. This takes advantage of the similarity between QMs of same type (Y/Cb/Cr, Intra/Inter) but intended for different block sizes.

The QM index matrixId proposed by JVET-O0223 is a compound of a size identifier sizeId (shown in Table 5) and a type identifier matrixTypeId (shown in Table 6), that are combined using the following equation 1-2, which results in the unique identifier matrixId show in Table 7.

matrixId=6*sizeId+matrixTypeId (1-2)

TABLE 5

| Luma | Chroma | sizeId |
|---|---|---|
| 64 × 64 | 32 × 32 | 0 |
| 32 × 32 | 16 × 16 | 1 |
| 16 × 16 | 8 × 8 | 2 |
| 8 × 8 | 4 × 4 | 3 |
| 4 × 4 | 2 × 2 | 4 |

TABLE 6

| CuPredMode | cIdx (Colour component) | matrixTypeId |
|---|---|---|
| MODE_INTRA | 0 (Y) | 0 |
| MODE_INTER | 0 (Y) | 1 |
| MODE_INTRA | 1 (Cb) | 2 |
| MODE_INTER | 1 (Cb) | 3 |
| MODE_INTRA | 2 (Cr) | 4 |
| MODE_INTER | 2 (Cr) | 5 |

TABLE 7

| | | | | | | | | | | | |
|---|---|---|---|---|---|---|---|---|---|---|---|
| Y | INTRA | 0 | | 6 | | 12 | | 18 | | 24 | |
| | INTER | 1 | | 7 | | 13 | | 19 | | 25 | |
| Cb | INTRA | | 2 | | 8 | | 14 | | 20 | | 26 |
| | INTER | | 3 | | 9 | | 15 | | 21 | | 27 |
| Cr | INTRA | | 4 | | 10 | | 16 | | 22 | | 28 |
| | INTER | | 5 | | 11 | | 17 | | 23 | | 29 |

| | | | | | |
|---|---|---|---|---|---|
| TU size: luma max | 64 | 32 | 16 | 8 | 4 |
| (width, height) | | | | | |

| | | | | | | |
|---|---|---|---|---|---|---|
| Block size: max | 64 | 32 | 16 | 8 | 4 | 2 |
| (width, height) | | | | | | |

| | | | | |
|---|---|---|---|---|
| Signalled QM size | 8 × 8 + DC | 8 × 8 | 4 × 4 | 2 × 2 |

Syntax is modified as highlighted by underlined text in table 8.

TABLE 8

| | De- |
|---|---|
| | scriptor |
| scaling_list_data( ) { | |
| for( matrixId = 0; matrixId < 30; matrixId++ ) { | |
| scaling_list_pred_mode_flag[ matrixId ] | u(1) |
| if ( !scaling_list_pred_mode_flag[ matrixId ] ) | |
| scaling_list_pred_matrix_id_delta[ matrixId ] | ue(v) |
| else { | |
| nextCoef = 8 | |
| coefNum = (matrixId < 20) ? 64 : (matrixId < 26) ? 16 : 4 | |
| if ( matrixId < 14 ) { | |
| scaling_list_dc_coef_minus8[ matrixId ] | se(v) |
| nextCoef = scaling_list_dc_coef_minus8[ matrixId ] + 8 | |
| } | |
| for( i = 0; i < coefNum; i++ ) { | |
| scaling_list_delta_coef | se(v) |
| nextCoef = (nextCoef + scaling_list_delta_coef + 256 ) | |
| % 256 | |
| ScalingList[ matrixId ][ i ] = nextCoef | |
| } | |
| } | |
| } | |
| } | |

The QM selection for a given transform block and adaptation to block size is performed as described in a separate section called “Scaling matrix derivation process”:
The selection of QM is based on the maximal dimension of TU, as shown in the following equation where blkWidth and blkHeight are the current transform block width and height, cIdx is the component index (0 for luma), SubWidthC and SubHeightC are the decimation factors of chroma in the horizontal and vertical directions, and predMode is the block prediction mode. The relevant part is underlined:

matrixId=6*sizeId+matrixTypeId (1-2)

with log 2TuWidth=log 2(blkWidth)+((cIdx>0) ? log 2(SubWidthC) : 0),

log 2TuHeight=log 2(blkHeight)+((cIdx>0) ? log 2(SubHeightC) : 0),

sizeId=6−max(log 2TuWidth, log 2TuHeight), and

matrixTypeId=(2*cIdx+(predMode==MODE_INTRA ? 0 : 1))
The adaptation to block size is then performed by applying appropriate bit shifts to x/y coordinates when scanning the selected QM, as illustrated in the following equation, where ScalingMatrix[matrixId] is the selected QM, log 2MatrixSize is the log 2 of the size of the ScalingMatrix[matrixId] square array, and m[ ][ ] is the derived quantization matrix that matches current block size:

m[x][y]=ScalingMatrix[matrixId][i][j] (1-3)

with i=(x<<log 2MatrixSize)>>log 2(blkWidth), and

j=(y<<log 2MatrixSize)>>log 2(blkHeight))

Embodiments described hereafter have been designed with the foregoing in mind. The encoder 100 of FIG. 1, decoder 200 of FIG. 2 and system 1000 of FIG. 3 are adapted to implement at least one of the embodiments described below and more particularly the quantization element 130 and inverse quantization elements 140 of the encoder 100 as well as the inverse quantization elements 240 of the encoder 200.

In at least one embodiment, the quantization matrix is determined based on the block area instead of the maximal value of the block size dimension (width or height). Having specific QMs for each block size actually allows adaptation to image content, and thus results in better visual quality. Indeed, choosing a QM of equal-area better match the idea of “size” than choosing a QM of the maximal dimension of the rectangular block. This follows the idea that equal-area blocks have better chance to be similar than block with equal max dimension (i.e. 16×4 is more alike 8×8 than 16×16). “size” is here understood as an “area” of a block but could also refer to a “sample count” or a “pixel count”. The principles introduced herein would also apply in such case.

In at least one embodiment, the quantization matrix used for video coding or decoding is selected based on a block area identifier whose value is determined as the integer value of an average of the log 2 of block width and height.

sizeId=(log 2 (width)+log 2 (height))/2

For example, a 16×4 block would give sizeId=3, just like an 8×8 block or 4×16 which have the same number of samples. Similarly, a 64×4 block would give sizeId of 4, like a 16×16 block or a 32×8 block which have the same number of samples. The table 9 illustrates the correspondence between block sizes and sizeId according to at least this embodiment. Other examples of correspondence may be used based on the same principles.

TABLE 9

| | Block width | | | | |
|---|---|---|---|---|---|
| Block height | 4 | 8 | 16 | 32 | 64 |
| 4 | 2 | 2 | 3 | 3 | 4 |
| 8 | 2 | 3 | 3 | 4 | 4 |
| 16 | 3 | 3 | 4 | 4 | 5 |
| 32 | 3 | 4 | 4 | 5 | 5 |
| 64 | 4 | 4 | 5 | 5 | 6 |

An offset could be applied to Table 9 so that to alter the range of values for sizeId. For example, an offset of −2 would lead in a range of values starting from 0.

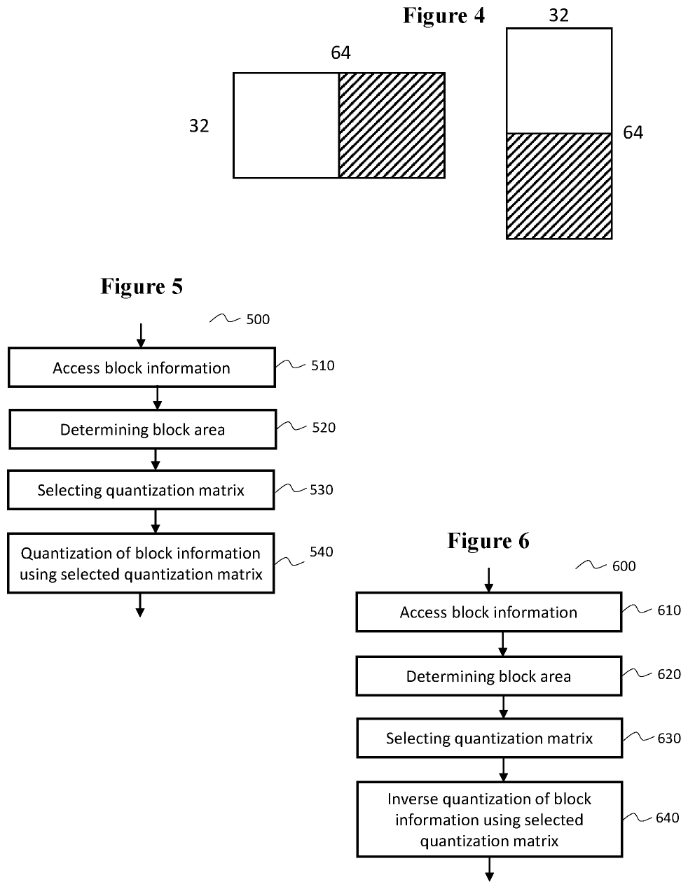

FIG. 5 illustrates an example embodiment of the quantization process for encoding wherein the quantization matrix is determined based on the block area. This process 500 is for instance implemented in the quantization module 130 of the encoder 100 of FIG. 1. In step 510, block information is accessed. Such information comprises at least the dimensions (width and height) of the block and the transformed coefficients to be encoded.

In step 520, a value representative of the block area is determined. In other words, the sizeId used in the selection of table 2 is determined. Multiple embodiments that allow to determine a value representative of the surface of a block (or of the number of samples which is equivalent) can be used for this step. For example, in at least one embodiment, a sizeId is determined as the average of the log 2 of block width and height as formulated above and the corresponding quantization matrix is selected based on the determined sizeId from a table (such as the table 4 shown above) that associates sizeIds to quantization matrices. In one example embodiment, this value is chosen as follows: sizeID=sqrt (width×height). In other example, it is chosen based on the number of subdivisions of the block (similarly than for the quantization groups) or using a series of comparisons with the number of samples or using tables or using range of values.

In step 530, the quantization matrix is selected based on the value representative of the block area. Then, in step 540, the quantization of the block information is performed using the selected quantization matrix. Further in the encoding process, the quantized transform coefficients are then encoded.

FIG. 6 illustrates an example embodiment of the inverse quantization process for decoding wherein the quantization matrix is determined based on the block area. This process 600 is for instance implemented in the inverse quantization module 240 of the encoder 200 of FIG. 2. In step 610, block information is accessed. Such information comprises at least the dimensions (width and height) of the block and the encoded coefficients to be decoded. In step 620, a value representative of the block area is determined. In other words, the sizeId used in the selection of table 2 is determined. The different embodiments described above for the step 520 apply also for step 620. In step 630, the quantization matrix is selected based on the value representative of the block area. Then, in step 640, the inverse quantization of the block information is performed using the selected quantization matrix.

When applied to VVC or to JVET-O0223, this selection of the block size identifier provides better visual quality while requiring minimal changes and complexity in the specification. Furthermore, the use of log 2 is very handy since it can be used for bit shifts as illustrated below.

In at least a first variant embodiment, the principle is applied to VVC. In such context, the text found in the semantics section of VVC draft 6 and introduced above is changed as follows. Changed or added text is underlined while removed text is removed and no more visible in this document.
For a quantization matrix with rectangular size, the five-dimensional array ScalingFactor[wId][hId][matrixId][x][y], with wId=0 . . . 6, hId=0 . . . 6, matrixId=0 . . . 5, x=0 . . . (1<<wId)−1, y=0 . . . (1<<hId)−1, and wId !=hId, specifies the array of scaling factors for size (1<<wId)×(1<<hId). The elements of ScalingFactor[wId][hId][matrixId][x][y] are generated by using ScalingList[avgSizeId][matrixId][i] with avgSizeId=(wId+hId+1)/2, as follows:

k=min(avgSizeId, 3),

ScalingFactor[wId][hId][matrixId][x][y]=ScalingList[avgSizeId][matrixId]

[Raster2DiagScanPos[k][k][(((y<<k)>>hId)<<+((x>>wId)]]

This example embodiment uses a value representative of the block area as an average of the log 2 of block width and height but any other embodiment allowing to determine a value representative of the surface of a block or of the number of samples could be used, such as those described above for the step 520 of FIG. 5.

In at least a second variant embodiment, the principle is applied to JVET-O0223. In such context, the equation performing the selection of QM based on block type and size, found in section “Scaling matrix derivation process” and introduced above, is modified as follows. Changed or added text is underlined while removed text is stroked.

matrixId=6*sizeId+matrixTypeId (Error! No text of specified style in document.−1)

with log 2TuWidth=log 2(blkWidth)+((cIdx>0) ? log 2(SubWidthC) : 0),

log 2TuHeight=log 2(blkHeight)+((cIdx>0) ? log 2(SubHeightC) : 0),

sizeId=6−(log 2TuWidth+log 2TuHeight+1)/2, and

matrixTypeId=(2*cIdx+(predMode==MODE_INTRA ? 0 : 1))

It should be noted that the “+1” increment of the modification is for rounding. It makes choosing larger QMs more probable which is preferable for data retaining reasons. Indeed, it reduces occurrence of coefficient repeats, which means more significant coefficients are retained. For example, with a block of 16×2, (log 2(16)+log 2(2))/2=2. Thus, a matrix of 4×4 coefficients is chosen (as shown Table 2) but needs to be repeated 4 times in the width of the block. There are only 4 different coefficients. When using the version with the increment, (log 2(16)+log 2(2)+1)/2=3 and there a matrix of 8×8 is selected. In this case, the repetition is only twice and there are 8 different coefficients, thus, improving the solution.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The aspects described and contemplated in this application can be implemented in many different forms. FIGS. 1, 2 and 3 provide some embodiments, but other embodiments are contemplated and the discussion of these figures does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

Various methods are described herein, and each of the methods comprises one or more steps or actions for achieving the described method. Unless a specific order of steps or actions is required for proper operation of the method, the order and/or use of specific steps and/or actions may be modified or combined.

Various methods and other aspects described in this application can be used to modify modules, for example, the quantization element 130 and inverse quantization elements 140 of the encoder 100 as well as the inverse quantization elements 240 of the encoder 200 as shown in FIG. 1 and FIG. 2. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, tablets, smartphones, cell phones, portable/personal digital assistants, and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information.

Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

In the present application, the terms “reconstructed” and “decoded” may be used interchangeably, the terms “pixel” and “sample” may be used interchangeably, the terms “image,” “picture”, “frame”, “slice” and “tiles” may be used interchangeably. Usually, but not necessarily, the term “reconstructed” is used at the encoder side while “decoded” is used at the decoder side.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of an illumination compensation parameter. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

1.-12. (canceled)

13. A method comprising:
obtaining a block of a picture;
determining an identifier based on an integer value of an average of a log 2 of a width and a height of the block of the picture;
selecting, from an ordered list of quantization matrices, a quantization matrix corresponding to the determined identifier;
quantizing the block of the picture using the selected quantization matrix; and
encoding picture data based on the quantized block.

14. The method of claim 13, wherein the integer value is determined by
(log 2 (W)+log 2 (H))/2,
wherein W is the width of the block, and H is the height of the block.

15. The method of claim 13, wherein the integer value is determined by
(log 2 (W)+log 2 (H)+1)/2,
wherein W is the width of the block, and H is the height of the block.

16. A method comprising:
obtaining information representative of a quantized block of a picture;
determining an identifier based on an integer value of an average of a log 2 of a width and a height of the block of the picture;
selecting, from an ordered list of quantization matrices, a quantization matrix corresponding to the determined identifier;
applying an inverse quantization to the block of the picture using the selected quantization matrix; and
decoding picture data based on the inverse quantized block.

17. The method of claim 16, wherein the integer value is determined by
(log 2 (W)+log 2 (H))/2,
wherein W is the width of the block, and H is the height of the block.

18. The method of claim 16, wherein the integer value is determined by
(log 2 (W)+log 2 (H)+1)/2,
wherein W is the width of the block, and H is the height of the block.

19. An apparatus configured to:
obtain a block of a picture;
determine an identifier based on an integer value of an average of a log 2 of a width and a height of the block of the picture;
select, from an ordered list of quantization matrices, a quantization matrix corresponding to the determined identifier;
quantize the block of the picture using the selected quantization matrix; and
encode picture data based on the quantized block.

20. The apparatus of claim 19, wherein the integer value is determined by
(log 2 (W)+log 2 (H))/2,
wherein W is the width of the block, and H is the height of the block.

21. The apparatus of claim 19, wherein the integer value is determined by
(log 2 (W)+log 2 (H)+1)/2,
wherein W is the width of the block, and H is the height of the block.

22. An apparatus configured to:
obtain information representative of a quantized block of a picture;
determine an identifier based on an integer value of an average of a log 2 of a width and a height of the block of the picture;
select, from an ordered list of quantization matrices, a quantization matrix corresponding to the determined identifier;
apply an inverse quantization to the block of the picture using the selected quantization matrix; and
decode picture data based on the inverse quantized block.

23. The apparatus of claim 22, wherein the integer value is determined by
(log 2 (W)+log 2 (H))/2,
wherein W is the width of the block, and H is the height of the block.

24. The apparatus of claim 22, wherein the integer value is determined by
(log 2 (W)+log 2 (H)+1)/2,
wherein W is the width of the block, and H is the height of the block.

25. A non-transitory computer readable medium comprising program code instructions for implementing the steps of a method according to claim 16 when executed by a processor.
